(19) United States
(12) Patent Application Publication
(10) Pub. No.: US 2013/0327941 A1
(43) Pub. Date: Dec. 12, 2013

(54) WIDE ANGLE OPTICAL SYSTEM

(71) Applicant: Gregory MODIEVSKY, Ramat Gan (IL)

(72) Inventor: Gregory MODIEVSKY, Ramat Gan (IL)

(21) Appl. No.: 13/491,664

(22) Filed: Jun. 8, 2012

(51) Int. Cl. G01J 1/04; G01T 1/00; G01J 5/10

(52) U.S. Cl. 250/338.1; 250/201.1; 250/336.1; 250/372

(57) ABSTRACT

A system for diverting wide angle incident electromagnetic radiation to parallel to an optical axis of a wide FOV lens. The system includes a wide FOV lens system including at least one wide FOV lens and an electromagnetic radiation sensitive device. The wide FOV lens system includes at least one wide FOV lens, the wide FOV lens includes a smooth outer surface that is transparent to the incident electromagnetic radiation. The wide FOV lens system is superposed over an outer surface of the electromagnetic radiation sensitive device, the electromagnetic radiation sensitive device is capable of interacting with the incident electromagnetic radiation.

### TECHNICAL FIELD

The present invention pertains to optical systems that complement electromagnetic radiation sensitive devices. In particular, the present invention pertains to optical systems that divert incident electromagnetic radiation from wide FOV (Field Of View) to parallel angle relative to the optical axis of an optical system and perpendicular to an electromagnetic radiation sensitive surface of an electromagnetic radiation sensitive devices.

### BACKGROUND

The technical problem of loss of wide angle or peripheral incident electromagnetic radiation relative to the perpendicular axis of electromagnetically sensitive devices has been addressed and solved in numerous ways in the prior art. In particular, several solutions were suggested for transmitting or concentrating incident solar radiation at wide angles relative to the axis perpendicular to photovoltaic panels: Fresnel and convex lenses, concentrating mirrors and complex combinations of lenses and mirrors that cause internal reflection in order to minimize energy loss.

According to current technologies and known art in the field of photovoltaic cells, the main problem remains that the daily arc-like motion of the sun allows for only partial transmittance of radiation to penetrate perfectly oriented solar panels within a limited portion of 50° of the arc (25° for each of east and west directions around the axis of symmetry perpendicular to the solar panel).

Another method for increasing refraction of incident radiation employs micro-scale lenses, for example by using textured surfaces. Such surfaces provide a plurality of angles of incidence for an incident radiation. This enables transmittance of wave-fronts even at wide angles.

Focusing technology is commonly used to overcome loss of incident radiation to concentrate it prior to use. Light transmission via reflective lenses or reflecting mirrors is employed to achieve concentration. The mirror-based technologies are difficult to manufacture and maintain, while the focusing technologies are limited mainly by constraints of focal lengths.

US 2011/0232721 addresses the problem of deflection of sunlight rays off photovoltaic cells due to non-flat structure of the cells. This occurs even when the rays are aimed at perfectly zero degree position relative to the cells. The solution offered is a photovoltaic enhancement transparent film with a structured surface forming an optical path that absorbs light incident also at wide angles and causes total internal reflection (TIR).

US 2011/0083664 employs Fresnel light shifting constructs based upon groups of Fresnel grooves to shift solar radiation onto solar energy receptors or devices and collects or concentrates the solar radiation at the targeted site.

US 2011/0079267 uses a combination of a flat shape lens and a flat or planar sheet with a structured surface. The sheet has an indented structure with small triangular grooves that split or redirect incident rays to a thermal or photovoltaic collector located at the edges of the sheet.

US 2010/0307480 uses the effect of internal reflection to enhance collection of light rays in solar panels in a structure of narrow ending transmitting prisms and a refractor situated over them.

US 2007/0023079 uses a holographic structure for diffraction grating to transmit light rays incident on a surface at different angles.

US 2004/0103938 offers a photovoltaic conversion layer in conjunction with an electrode and a light concentrator to prevent loss of incident light.

U.S. Pat. No. 6,700,055 uses Fresnel lenses that concentrate solar rays onto an array of photovoltaic cells. The lenses adjust their position relative to the movement of the sun in order to maintain the focal point of the incident radiation on the solar cells.

U.S. Pat. No. 7,068,446 describes a non-imaging optical system that includes at least two refractive surfaces, at least one reflective surface nearer to the first light distribution along at least one ray path than the nearer of the two refracting surfaces and the reflective surface and the refractive surfaces cooperating to redirect light edge rays of the first light distribution into the neighborhood of the edge of the second light distribution with a single reflection from the reflecting surface.

The solutions in the prior art described above contain several disadvantages. They either require use of mirrors and collectors for redirecting incident radiation or micro-scaled structured lenses to cover also wide angles. The micro-scaling of incident surface may increase transmittance of radiation but also the surface area in which dust and impurities can be accumulated on and between the micro-lenses. This diminishes transmittance counteracting the advantage of the micro-scale solution. It also requires constant and continuous maintenance to avoid reflection of incident radiation.

It is, therefore, an object of the present invention to respond to the existing need to provide a system that overcomes the deficiencies of the systems known in the prior art.

Yet, it is another object of the present invention to provide a system that is mechanically simple yet efficient in transmitting incident radiation at wide angles.

Yet, it is another object of the present invention to provide systems for transmitting wide angle incident radiation that may be applied for all ranges of the electromagnetic radiation spectrum.

Yet, it is another particular object of the present invention to provide a system that transmits wide angle solar radiation, which occupies a range of wavelengths in the electromagnetic radiation spectrum, to photovoltaic panels and increases efficiency of conversion of solar energy to electrical energy.

Yet, it is another particular object of the present invention to provide a system that transmits wide angle incident solar radiation onto solar panels and does not cause overheating of these panels.

This and other objects and advantages of the present invention will become apparent as the description proceeds.

### SUMMARY OF THE INVENTION

In one aspect, the present invention provides a system that combines a wide FOV lens system with an electromagnetic radiation sensitive device. In particular, the present invention provides a system that combines wide FOV lens system with electromagnetic radiation sensitive device, where the lens is configured to transmit electromagnetic radiation energy through to the electromagnetic radiation sensitive device.

In another aspect of the present invention, the wide FOV lens system is superposed over the electromagnetic radiation sensitive surface of the electromagnetic radiation sensitive device, and positioned towards a source or a plurality of sources that emit electromagnetic radiation in a range of wavelengths that the device is sensitive to. Incident wave front with an axis perpendicular to the lens will be transmitted through the lens without change in its original direction. Incident wave fronts at any other angle relative to the perpendicular axis of the lens will be refracted by the lens. The lens will then divert the direction of propagation of these wave fronts parallel relative to the optical axis of the lens. The surface of the radiation sensitive device is coordinated with the wide FOV lens such that optical axis of the lens is perpendicular to the radiation sensitive surface of the device. Therefore, any wave front propagation that is parallel to the optical axis will be perpendicular to the radiation sensitive surface of the device. Such assembly of wide FOV lens and electromagnetic radiation sensitive device enables interacting with incident radiation that would otherwise be greatly attenuated and any energy or information it might carry would be diminished.

It should be noted that throughout the specification and claims it is meant that propagation of a wave front generates an electromagnetic radiation beam. The beam propagates along a vector in the direction of propagation of the wave front.

Thus, in another aspect, the present invention provides a system that combines a wide FOV lens and an electromagnetic radiation sensitive device, which is adapted to enhance response of the device by enabling a larger amount of incident radiation to transmit through the lens and interact with the device.

In still another particular embodiment, the outer and inner surfaces of the wide FOV lens are configured with varying curves. That is, the outer and inner surfaces of the wide FOV lens may be configured independently of each other at any curve between flat and convex. Any configuration of the lens surfaces can be located with inside the construction of the electromagnetic radiation sensitive device, beneath a protecting surface, e.g., a protecting glass plate of a photovoltaic panel. The advantage of such location inside the panel protects the lens from abrasion, damaging UV radiation, braking and ware.

In still another particular embodiment, the wide FOV lens is configured with curved outer and curved inner surfaces.

In still another aspect, the wide FOV lens of the present invention comprises a single smooth outer surface that prevents accumulation of impurities, dust and particles.

In still another aspect of the present invention, the wide FOV lens is superposed over the entire surface of an electromagnetic radiation sensitive device. The full coverage of the surface of the devices ensures uniform distribution of energy over the device. This quality is essential for, example, in enabling performance of a photovoltaic panel.

Full coverage of the surface of the device is achieved with any geometrical shape of the lens that enables it. Thus, in one non-limiting example of the present invention, the wide FOV lens is implemented as a cylindrical lens. In still another particular non-limiting example, the wide FOV lens is implemented as a hexagonal lens. In a further particular embodiment, the advantage of the hexagonal lens is in intercepting the incident radiation during daily east-west arc-like movement of the sun and the seasonal change of the angle of the sun relative to the surface of the earth (the change being between approximately between 25° and 70°). Accordingly, the hexagonal lens increases the amount of electromagnetic radiation energy received by the electromagnetic radiation sensitive device.

The materials from which the lens is made are selected such that they allow the transmission of the particular wavelength range of the incident electromagnetic radiation. Particularly, the index of refraction of the materials reflects their capability to transmit incident electromagnetic radiation in a particular wavelength range. Therefore, in one particular embodiment of the present invention, the material for the wide FOV lens is selected such that its index of refraction and maximum transparency to certain wavelength ranges (i.e., minimum loss of energy) enable transmission of electromagnetic radiation at a particular wavelength range. Non-limiting examples are polycarbonate, PET (polyethylene terephthalate) and glass for solar radiation and Teflon for RF radiation.

Selection of the material for the lens is made by optimizing efficiency of transmission of radiation, durability under climate and weather conditions and costs and feasibility of production.

In still another particular embodiment, the thickness of the lens is determined according to strength, durability under service conditions, climate and weather conditions and optical requirements for enabling a wide FOV of the lens. In general, the thickness of the lens is determined to minimize losses while considering mechanical constraints relating to assembling the lens and the electromagnetic radiation sensitive device and the dimensions of the lens, technological constraints relating mainly to the production of the lens and the material of the lens. In one particular non-limiting example, the thickness of the lens is about 0.5 millimeter. In still another particular embodiment, the thickness of the lens is about 5% of the width of the lens.

In still another particular embodiment for photovoltaic panels, the glass plate that protects the photovoltaic cells is configured as a wide FOV lens. The outer and inner surfaces of the plate may be configured independently of each other with any curve between completely flat and convex. In still another particular embodiment, the outer surface of the plate is flat.

In still another aspect, the present invention can be implemented in different ranges of wavelength of the electromagnetic spectrum. Any wide FOV lens adapted to transmit a certain electromagnetic wavelength range can be combined with a device that is sensitive to the particular wavelength range. The lens will then increase the interaction of the device with an incident radiation at that particular range by refracting wide angle incident radiation to a perpendicular wave front advancing towards the radiation sensitive surface of the device.

In one particular embodiment, the present invention is implemented on a photovoltaic panel, where a wide FOV lens made of a material transparent to solar radiation and with particular index of refraction is superposed over an array of photovoltaic cells. Each lens is adapted to cover an array of photovoltaic cells. Therefore, in still another particular embodiment, the present invention provides a plurality of wide FOV lenses assembled with a plurality of photovoltaic arrays, where each lens is superposed over each array, and where the array forms a solar panel.

In still another particular embodiment, the present invention provides a system that combines a wide FOV lens system with an electromagnetic radiation sensitive device, where the incident radiation is modulated to carry information transmitted through the lens and received by a radiation sensitive surface of the device. The wide FOV lens diverts wide angle incident wave fronts to parallel wave fronts relative to an axis perpendicular to the lens and the sensitive surface of the device. This way, the signal intercepted by the device is stronger, and a larger amount of incident radiation and more reliable information is processed by the device. Such particular implementation is useful especially in RF (radio-frequency) radiation modulated signals transmitting information carrying signals that can be uni- or multi-directional. However, the system may transmit, intercept and process modulated electromagnetic radiation at any wavelength range since the same principle of diverting wide angle to parallel relative to the lens optical axis incident radiation applies.

Accordingly, in one aspect, the invention provides a system that comprises a wide FOV lens and an electromagnetic radiation sensitive device, where the wide FOV lens is transparent to the certain wavelength range to which the device is sensitive. In one embodiment, the present invention provides a system that comprises a wide FOV lens that is made of a material that is transparent to the incident radiation at a particular range of electromagnetic wavelength. In still another embodiment, the wide FOV lens may also be structured to enable transmittance of the incident radiation.

Photosensitive solar panels experience varying angles of incidence of solar rays as the sun makes an arc route in the sky. Accordingly, a system having a plurality of wide FOV lenses superposed over the panel and covering its entire surface or a single wide FOV covering the entire surface ensures that a larger percent of energy of incident solar rays is transmitted through to the solar panel. Moreover, equal distribution of energy is essential to the operation of the photovoltaic panel. Such uniform distribution is facilitated by the complete covering of the panel with a panel of a wide FOV lens system. This is in contrast to currently used technologies of concentration lenses that focus energy on a particular area of the panel.

In still another embodiment, the present invention provides a system that comprises a wide FOV lens and an electromagnetic radiation sensitive device, where the wide FOV lens is combined with an auxiliary lens for correcting deviations and aberrations of electromagnetic wave fronts transmitted through the wide FOV lens. Generally, such deviations and aberrations are due to tolerances and small inaccuracies in the wide FOV lens occurring in its process of production. Specifically, these inaccuracies are mainly in the match between the width of the lens and the electromagnetic radiation sensitive device. The auxiliary lens is then required to correct these deviations and aberrations

In still another embodiment, the present invention provides a system that comprises a plurality of wide FOV lenses superposed on an electromagnetic radiation sensitive device. In one particular embodiment, the electromagnetic sensitive device is a photovoltaic panel formed of a plurality of photovoltaic arrays, each array formed of photovoltaic cells, and each of the plurality of wide FOV lens systems is superposed on a single array.

In still another embodiment, the present invention provides a system comprising at least one wide FOV lens system superposed on an electromagnetically radiation sensitive device, where the device may be sensitive to any one of RF, near IR, far IR, soft UV, ultra UV, soft X and hard X radiation. It should be understood that this list of types of electromagnetic radiation is not exhaustive. Additional ranges of electromagnetic wavelengths may be contemplated in designing a system having wide FOV lens system superposed over an electromagnetic radiation sensitive device, where the lens is made of a material that transmits the particular wavelength range emitted from an electromagnetic radiation emitting source. Likewise, the device is sensitive to the particular wavelength range that is emitted from the source and transmitted through the lens.

In still another embodiment, the present invention provides a system comprising at least one wide FOV lens system and electromagnetic radiation sensitive device, where the system is configured for radar detection applications.

In still another embodiment, the present invention provides a system having at least one wide FOV lens system and electromagnetic radiation sensitive device, where the system is configured for night vision applications by detecting IR emitting bodies.

In still another embodiment, the present invention provides a system comprising at least one wide FOV lens system and an electromagnetic radiation sensitive device, where the system is configured for interacting with passively or actively electromagnetic emitting radiation sources. In principle, the system of the present invention is indifferent to the way the electromagnetic radiation is generated by the source. However, it may be adapted to interact as well with actively radiation emitting sources.

In still another embodiment, the present invention provides a system comprising at least one wide FOV lens system and an electromagnetic radiation sensitive device, where the system is configured to interact with stationary or moving electromagnetic radiation emitting sources.

The following will describe a particular embodiment of the presenting invention that should be construed as a non-limiting example of the present invention.

### BRIEF DESCRIPTION OF THE DRAWINGS

FIG. 1A schematically illustrates a particular case of a convex cylindrical lens and refraction of incident wave front through the lens.

FIG. 1B schematically illustrates a particular case of a concave cylindrical lens and refraction of incident wave front through the lens.

FIG. 2A schematically illustrates incoming radiation incident at perpendicular angle upon a radiation sensitive device.

FIG. 2B schematically illustrates incoming radiation incident at wide angle upon the surface of a radiation sensitive device.

FIG. 3A schematically illustrates incident radiation at perpendicular angle upon a wide FOV lens superposed over the surface of a radiation sensitive device.

FIG. 3B schematically illustrates incident radiation at wide angle upon a wide FOV lens superposed over the surface of a radiation sensitive device.

FIG. 4A exemplifies the total energy of incident radiation transmitted to an electromagnetic radiation sensitive device.

FIG. 4B exemplifies the total energy of incident radiation transmitted through a wide FOV lens to a electromagnetic radiation sensitive device.

FIG. 5A schematically illustrates a wide FOV cylindrical lens and a wide FOV cylindrical lens with a correcting lens

FIG. 5B schematically illustrates an array of wide FOV cylindrical lenses.

FIG. 5C schematically illustrates an array of wide FOV cylindrical lenses with an array of correcting lenses.

FIG. 5D schematically illustrates a matrix of wide FOV cylindrical lenses.

FIG. 5E schematically illustrates a matrix of wide FOV cylindrical lenses with a matrix of correcting lenses.

FIG. 6A schematically illustrates a focusing lens used in the current technology known in the art.

FIG. 6B schematically illustrates a wide FOV lens of the present invention.

### DETAILED DESCRIPTION OF PREFERRED EMBODIMENTS

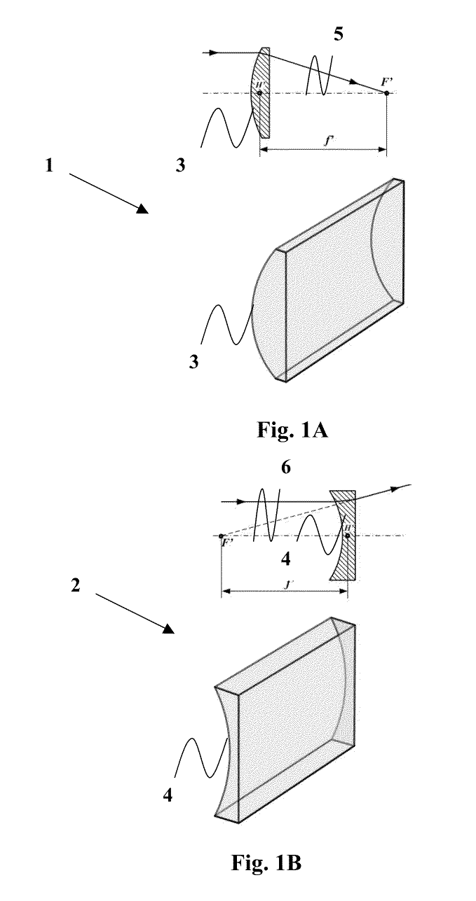

FIGS. 1A and 1B depict a schematic of convex (1) and concave (2) cylindrical lenses, respectively. The lenses focus light which passes through on to a line instead of on to a point, as a spherical lens would. The curved face or faces (3, 4) of the lenses are sections of a cylinder, and focus the image passing through it onto a line (5, 6) parallel to the intersection of the surface of the lens and a plane tangent to it. The lenses compress the image in the direction perpendicular to this line, and leaves it unaltered in the direction parallel to it (in the tangent plane).

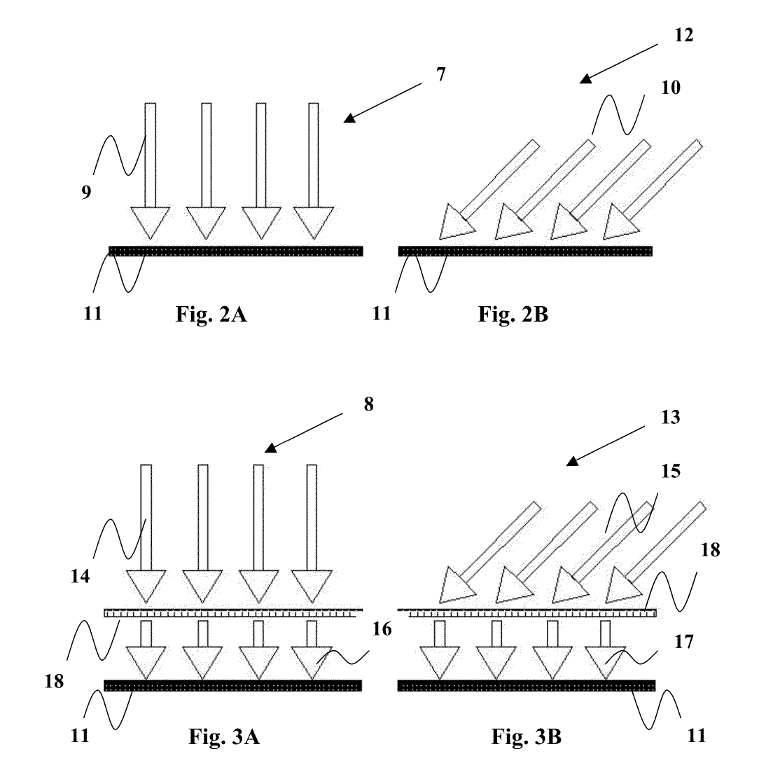

FIGS. 2A and 3A illustrate a schematic representation (7, 8) of a wave front (9, 14) incident at a perpendicular direction relative to a surface of an electromagnetic radiation sensitive device (11). FIG. 2A illustrates the incidence of the perpendicular wave front (9) directly at the surface of the device (11). In such situation, all the incoming radiation is absorbed and processed by the device without reflection and losses. Introducing an optical system (18), specifically a wide FOV lens, which is transparent to the particular wavelength of the radiation, does not divert the propagation of the wave front from its original perpendicular direction (16). The energy contained in the incident radiation is thus fully transmitted through the lens and absorbed by the device.

FIGS. 2B and 3B illustrate a schematic representation (12, 13) of a wide angle incident wave front (10, 15) relative to an axis perpendicular to the surface of the electromagnetic radiation sensitive device (11). The intensity of the electromagnetic radiation of the wave front (10) will be attenuated proportionally to the cosine of the angle of incidence with the device (11). Introducing the optical system (18), specifically a wide FOV lens, will allow transmission of the incident radiation through the lens relative to the axis perpendicular to the lens. After transmitting the wave front (15) the lens will divert it from its original angle to propagate parallel (17) to the axis perpendicular to the surfaces of the lens and the device. This way, the amount of radiation transmitted to the surface of the device is increased significantly. The attenuation is then minimal and results only from the lens material properties and production limitations.

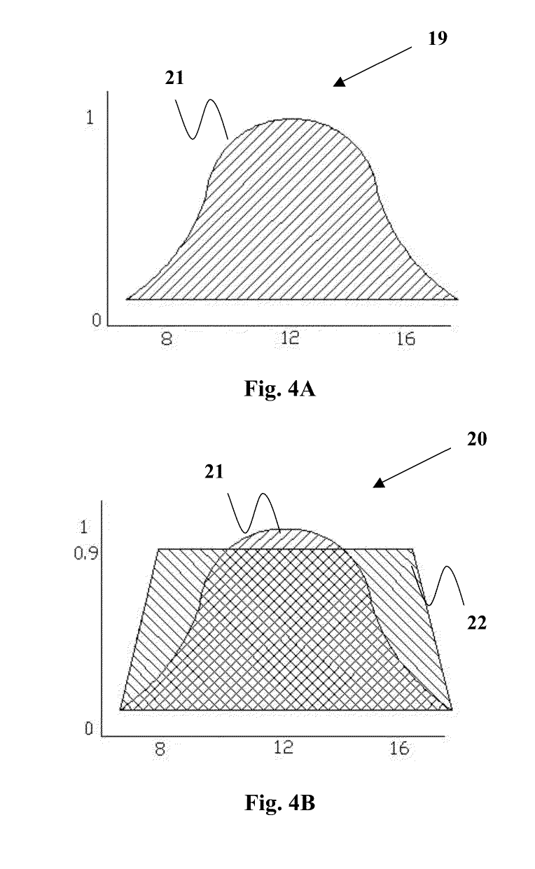

In a particular non-limiting example, FIGS. 4A and 4B schematically demonstrate the differential amount of radiation energy transmitted without and with a wide FOV lens superposed on an electromagnetic radiation sensitive device. FIG. 4A shows the amount of solar radiation energy transmitted during daytime in a photovoltaic panel (19). The area under the bell (21) reflects the amount of solar energy transmitted to the panel, where the area is proportional to the cosine of the angles of incidence of the solar radiation. In FIG. 4B, a photovoltaic panel equipped with an optical system, specifically a wide FOV lens system, superposed on it, is measured (20). For comparison, the area under the bell (21) reflects the solar energy transmitted during daytime in the panel without the wide FOV optical system. However, as can be clearly seen, the wide FOV lens system increases significantly the amount of solar radiation transmitted beyond the area of the bell (21). The difference between the area under the bell (21) and the area under the trapeze (22) reflects the increase in transmission of energy as a result of superposing a wide FOV lens system over the photovoltaic panel. This is due to increasing the FOV of the lens that enables transmitting incident radiation at wide angles Employing wide FOV lens for transmitting solar radiation to a photovoltaic panel will increase the amount of energy transmitted to the photovoltaic panel and will be reflected in FIG. 4B in a greater area (22) under the trapeze. It should be noted that the trapeze in FIG. 4B is only a general representation of the solar energy transmitted through the wide FOV lens. In practice, the shape of the trapeze will be affected by environmental and optical conditions.

The residual area of the bell (21) above the trapeze (22) in FIG. 4B reflects the amount of energy collected from a scattered radiation. The wide FOV lenses of the present invention are mainly aimed at increasing transmission of direct incident radiation. The contribution of the scattered radiation to the total energy collected is marginal, although wide FOV lenses of the present invention allow its transmission to the device as well.

It should be noted that energy loss due to lack of transparency of lenses that are not ideal is about 10% of the total incident radiation. This loss can be reduced with appropriate selection of material to make the lenses and design and manufacturing processes of such lenses.

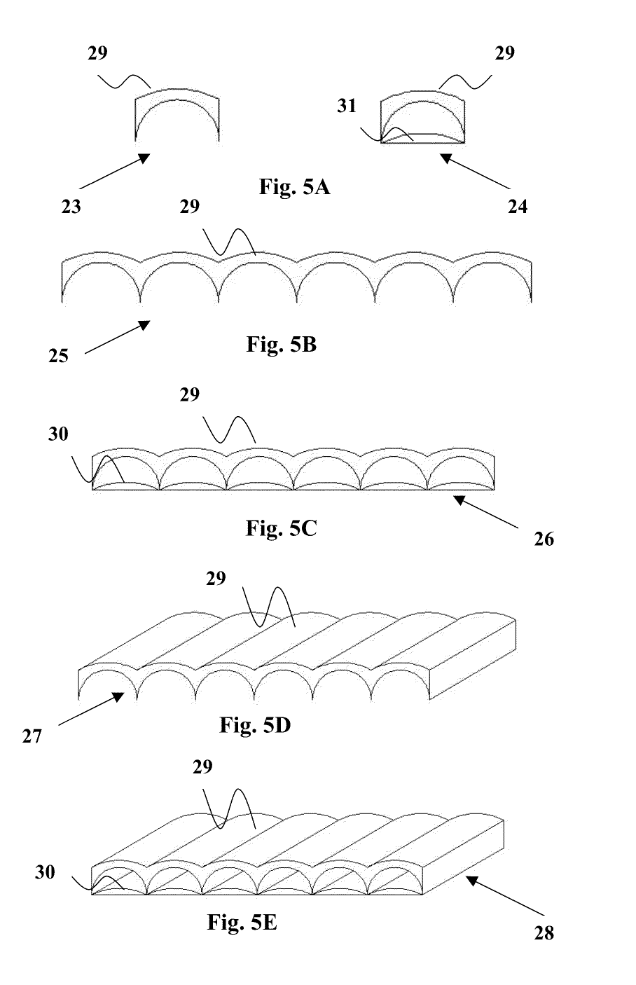

FIGS. 5A through 5E illustrate a schematic representation of wide FOV cylindrical lenses employed in the present invention. The cylindrical lens has smooth convex outer surface (29) that enables diverting incident wide angle radiation to perpendicular radiation relative to the surface of the lens and the surface of an electromagnetic radiation sensitive device. FIG. 5A illustrates two options for a cylindrical lens of the present invention. The first lens to the left (23) includes only a cylindrical lens with a smooth convex outer surface (29) with a wide FOV. The second lens to the right (24) incorporates an auxiliary lens (31) for correcting deviations, aberrations and disturbances experienced after transmission of the wave front through the cylindrical lens (29). This auxiliary lens further enhances the amount of radiation intercepted and transmitted to the device and provides improved energy conversion, for example, or a more reliable signal carrying an amount of information to be processed. It is required to correct small inconsistencies of the wide FOV lens shape and dimensions resulting from tolerances inherent to mass production of the lens system.

FIGS. 5D and 5E illustrate side and isometric views of a matrix of wide FOV cylindrical lenses without (25, 27) and with (26, 28) auxiliary lenses (30). Normally, for the application in photovoltaic panels, an array of lenses will be superposed over an array of photovoltaic cells. A plurality of arrays may then cover an entire photovoltaic panel. This provides a smooth convex surface over complete rows of cells, increases transmittance of solar radiation and ensures easy positioning of the lenses over the panels.

In one particular embodiment, the lenses matrix may be superposed over the panel with a pressure sensitive adhesive or attached to the panel with mechanical means, e.g., bolts, nuts, screws and the like.

In a further particular embodiment, the lenses matrix is modular and can be assembled onsite and superposed over the electromagnetic radiation sensitive device.

In still another particular embodiment, the lenses matrix or array is monolithic and can be cut to desirable size according to the dimensions of the electromagnetic radiation sensitive device.

In still another particular embodiment, the lenses matrix is detachable from the electromagnetic radiation sensitive device either as one piece or separately as arrays from which it is composed.

In still another particular embodiment, the lenses matrix is composed of individual hexagonal lenses which are wide FOV lenses. In still another particular embodiment, the lenses matrix is formed of arrays of hexagonal lenses which are wide FOV lenses.

In addition, transmittance of wide angle incident radiation also increases the area of the panel that is exposed to the radiation. This also increases the efficiency of energy conversion and, for example, the amount of electrical power converted from solar radiation or RF signal strength.

It should be noted that the wide FOV systems, arrays and matrixes and physical principles discussed above apply also to various wavelength ranges and materials from which the wide FOV lenses are made, as long as transmittance of the particular wavelengths through the lenses is possible.

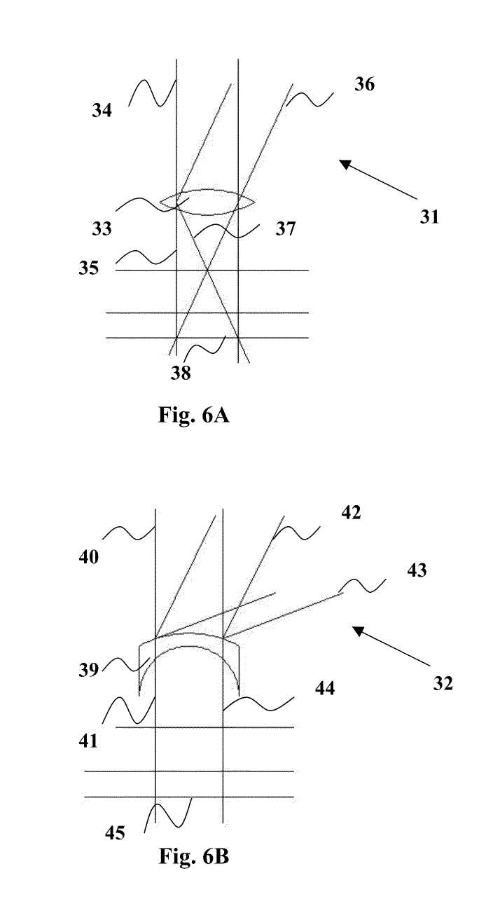

The differences in the optics and technical requirements between a focusing lens (31), which is currently used in the art, and the wide FOV lens (32) are illustrated in FIGS. 6A and 6B, respectively. FIG. 6A shows a focusing lens (33) that refracts and transmits incident radiation perpendicular (34) and angled (36) relative to an optical axis (not shown) perpendicular to the lens (33). The lens (33) transmits the perpendicular wave front (34) in its original direction (35) and refracts (37) the angled radiation (36) according to its angle of incidence, the index of refraction and curvature of the lens surfaces (33). However, in order to reach the surface (38), of a photovoltaic panel for instance, the curvature of the lens (33) and its distance from the surface (38) have to be pre-calculated and accurately measured. Additionally, if imaging is required, then a surface of the panel (38) that receives the radiation has to be placed in the focal plane of lens (33).

On the other hand, the wide FOV lens (39) in FIG. 6B is free of accurately positioning the surface (45) of the electromagnetic radiation sensitive device relative to the lens (39). Incident radiation (40) perpendicular to the lens and parallel to the optical axis of the lens will continue its original propagation (41) after transmitted through the lens (39). Incident radiation which is angled (42, 43) relative to the optical axis of the lens (not shown) (39) will be diverted by the lens to a parallel propagation (44) relative to the optical axis of the lens (39). The positioning of a wide FOV lens (39) relative to a surface (45) of an electromagnetic radiation sensitive device is not bound by optical constraints. That is, the distance of the lens (39) from the surface (45) does not depend on any focusing requirement of the radiation on the focal plane of the lens (39). Thus, theoretically, the wide FOV lens (39) can be positioned at any distance from a surface (45) of an electromagnetic radiation sensitive device, subject only to mechanical and/or technological constraints.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A system for diverting wide angle incident electromagnetic radiation to parallel to optical axis of a wide FOV lens, comprising:
a wide FOV lens system comprising at least one wide FOV lens; and
an electromagnetic radiation sensitive device;
said wide FOV lens system comprising at least one wide FOV lens, said wide FOV lens comprising a smooth outer surface that is transparent to said incident electromagnetic radiation,
said wide FOV lens system is superposed over an outer surface of said electromagnetic radiation sensitive device, said electromagnetic radiation sensitive device is capable of interacting with said incident electromagnetic radiation.

2. The system of claim 1, wherein outer and inner surfaces of said wide FOV lens are configured to divert incident electromagnetic radiation of any angle to propagate parallel to an optical axis of said wide FOV lens.

3. The system of claim 1, wherein the wide FOV lens system is configured to be placed above or under a protective shield of the electromagnetic radiation sensitive device.

4. The system of claim 1, wherein an outer and inner surfaces of said wide FOV lens are curved independently of each other at any curve between flat and convex.

5. The system of claim 1, wherein said wide FOV lens is cylindrical or hexagonal.

6. The system of claim 1, wherein said wide FOV lens is made of a material transparent to electromagnetic wavelength range to which said electromagnetic radiation sensitive device is sensitive.

7. The system of claim 6, wherein said material is selected from glass, polycarbonate, PET or any other material that is transparent to solar radiation and the system of claim 6, or wherein said material is Teflon or any other material that is transparent to RF radiation.

8. The system of claim 1, wherein said wide FOV lens is configured with a thickness that minimizes losses.

9. The system of claim 8, wherein said thickness is about 5% of a width of said wide FOV lens.

10. The system of claim 8, wherein said thickness is 0.5 millimeter.

11. The system of claim 1, wherein said wide FOV lens system comprises a plurality of wide FOV lenses, said plurality of wide FOV lenses is arranged in a matrix order and superposed over an entire array of electromagnetic radiation sensitive components of said electromagnetic radiation sensitive device.

12. The system of claim 1, wherein said electromagnetic radiation sensitive device comprises a plurality of arrays of electromagnetic radiation sensitive components, each of said plurality of said arrays of electromagnetic radiation sensitive components is superposed on an array of wide FOV lenses of said matrix order of said plurality of wide FOV lenses.

13. The system of claim 1, wherein said wide FOV lens system is attached to said electromagnetic radiation sensitive device with pressure sensitive adhesive.

14. The system of claim 1, wherein said wide FOV lens system is attached to said electromagnetic radiation sensitive device with mechanical means, said mechanical means are selected from bolts, screws, clips, nuts and the like.

15. The system of claim 12, wherein said matrix comprises a plurality of arrays of wide FOV lenses.

16. The system of claim 12, wherein said matrix is monolithic.

17. The system of claim 12, wherein said matrix is modular, said arrays are configured to connect to each other to form said matrix.

18. The system of claim 12, wherein said matrix is configured for onsite assembling with said electromagnetic radiation sensitive device.

19. The system of claim 1, wherein said wide FOV lens system is transparent to incident electromagnetic radiation emitted from the sun, said electromagnetic radiation sensitive device is a photovoltaic panel.

20. The system of claim 19, wherein said wide FOV lens system comprises an outer and inner surfaces that are curved independently of each other at any curve between flat and convex, said wide FOV lens system is configured to be placed under a protective flat surface of said photovoltaic panel.

21. The system of claim 19, wherein said wide FOV lens system comprises an outer and inner surfaces that are curved independently of each other at any curve between flat and convex, said lens system is configured to be placed above a protective flat surface of said photovoltaic panel.

22. The system of claim 1, wherein said photovoltaic panel comprises a protective glass surface, said protective glass surface is configured as a wide FOV lens comprising outer and inner surfaces, said surfaces are curved independently of each other at any curve between flat and convex.

23. The system of claim 1, wherein said wide FOV lens system is transparent to electromagnetic radiation wavelength ranges selected from IR incident electromagnetic radiation emitted from heat producing sources, said electromagnetic radiation sensitive device is suitable for night vision; RF incident electromagnetic radiation, said electromagnetic radiation sensitive device is radar equipment; UV incident electromagnetic radiation, said electromagnetic radiation sensitive device is UV equipment; and X-ray incident electromagnetic radiation, said electromagnetic radiation sensitive device is X-ray imaging device.
